(19) United States
(12) Patent Application Publication
(10) Pub. No.: US 2026/0081717 A1
(43) Pub. Date: Mar. 19, 2026

(54) RELAY DEVICE, COMMUNICATION SYSTEM, AND COMMUNICATION METHOD

(71) Applicant: Mitsubishi Electric Corporation, Tokyo (JP)

(72) Inventor: Hideo YOSHIDA, Tokyo (JP)

(73) Assignee: Mitsubishi Electric Corporation, Tokyo (JP)

(21) Appl. No.: 19/392,429

(22) Filed: Nov. 18, 2025

Related U.S. Application Data
(63) Continuation of application No. PCT/JP2023/027194, filed on Jul. 25, 2023.

(51) Int. Cl. H04L 1/00; H04B 7/185

(52) U.S. Cl. CPC H04L 1/0042; H04B 7/185

(57) ABSTRACT

A relay device performs signal relay between a transmission device that transmits a first modulated signal obtained by modulating a first error-correction code sequence generated by performing a first error-correction encoding process on an information sequence and a reception device serving as a destination of the first modulated signal. The relay device includes a first soft demodulator that generates a first soft demodulated sequence including reliability information corresponding to the first modulated signal; a second error-correction encoder that performs a second error-correction encoding process on an information sequence including the first soft demodulated sequence to generate a second error-correction code sequence; and a second modulator that transmits a second modulated signal obtained by modulating the second error-correction code sequence.

### CROSS-REFERENCE TO RELATED APPLICATION

This application is a continuation application of International Application PCT/JP2023/027194, filed on July 25, 2023, and designating the U.S., the entire contents of which are incorporated herein by reference.

### INVENTION DESCRIPTION

### BACKGROUND OF THE INVENTION

### 1. Field of the Invention

The present disclosure relates to a relay device, a communication system, and a communication method for performing error-correction processing on communication data.

### 2. Description of the Related Art

In the field of data communication, a commonly used technique for correcting errors that occur during data transmission involves performing error-correction encoding on data at a transmission device and error-correction decoding at a reception device. As data transmission distance increases, errors that occur during transmission become more significant, often degrading transmission quality. Therefore, not only the transmission device but also a relay device that relays data between the transmission device and the reception device performs error-correction encoding in proposed technologies.

For example, in a communication system disclosed in Japanese Patent No. 5933862, data that has undergone error-correction encoding, which is premised on hard-decision decoding, at a transmission device undergoes further error-correction encoding at relay devices without error-correction decoding. This communication system includes the plurality of relay devices. Among the plurality of relay devices, an intermediate relay device performs error-correction encoding premised on hard-decision decoding, while only the final relay device performs error-correction encoding premised on soft-decision decoding before transmission to a reception device.

However, a problem with the above conventional technology is that when the transmission distance between the transmission device and the relay device is long, there is an increased probability of error occurrence that can lead to an increased possibility of insufficient correction capability in error-correction encoding premised on hard-decision decoding, which may result in reduced communication reliability. For example, when the transmission device is installed on the Moon and the relay device is installed on an artificial satellite orbiting the Earth, the transmission distance from the transmission device to the relay device is long, and there is a high possibility that the correction capability will be insufficient in the error-correction encoding premised on the hard-decision decoding.

### SUMMARY OF THE INVENTION

In order to solve the above-described problems, a relay device according to the present disclosure is a relay device that performs signal relay between a transmission device and a reception device, the transmission device being configured to transmit a first modulated signal obtained by modulating a first error-correction code sequence generated by performing a first error-correction encoding process on an information sequence, the reception device serving as a destination of the first modulated signal, the relay device comprising: a first soft demodulator to generate a first soft demodulated sequence including reliability information corresponding to the first modulated signal; a second error-correction encoder to perform a second error-correction encoding process on an information sequence including the first soft demodulated sequence to generate a second error-correction code sequence; and a second modulator to transmit a second modulated signal obtained by modulating the second error-correction code sequence.

### BRIEF DESCRIPTION OF THE DRAWINGS

FIG. 1 is a diagram illustrating a configuration of a communication system according to a first embodiment;

FIG. 2 is a diagram illustrating functional configurations of a transmission device, a relay device, and a reception device that are illustrated in FIG. 1;

FIG. 3 is a diagram illustrating dedicated hardware for implementing functions of the transmission device, the relay device, and the reception device according to the first embodiment;

FIG. 4 is a diagram illustrating a configuration of a control circuit for implementing the functions of the transmission device, the relay device, and the reception device according to the first embodiment;

FIG. 5 is an explanatory diagram of a second error-correction encoding process according to a second embodiment; and

FIG. 6 is an explanatory diagram of a second modulation process according to a third embodiment.

### DETAILED DESCRIPTION OF THE PREFERRED EMBODIMENTS

With reference to the drawings, a detailed description is hereinafter provided of relay devices, communication systems, and communication methods according to embodiments of the present disclosure.

### First Embodiment.

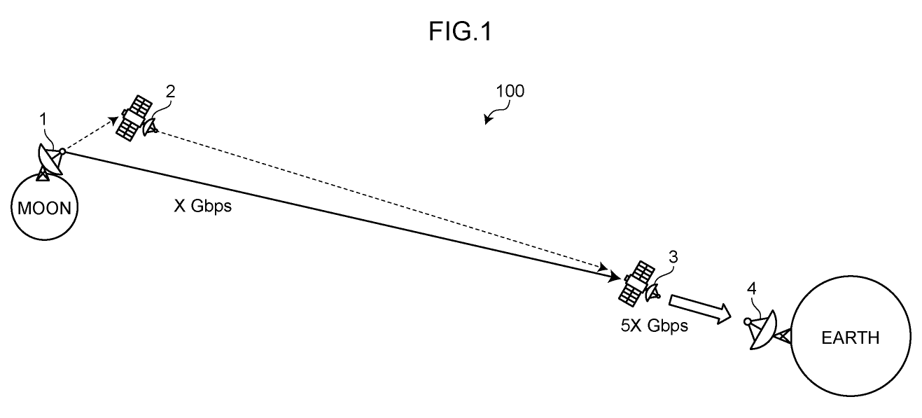

FIG. 1 is a diagram illustrating a configuration of a communication system 100 according to a first embodiment. The communication system 100 includes a transmission device 1 of a transmitting station installed on the Moon, a relay satellite 2 orbiting the Moon, a relay device 3 installed on an artificial satellite orbiting the Earth, and a reception device 4 of a receiving station installed on the Earth. Signals transmitted by the transmission device 1 are delivered to the reception device 4 via the relay device 3.

The transmission device 1 performs first error-correction encoding on an information sequence of transmission data to generate a first error-correction code sequence and transmits a modulated signal obtained by modulating the first error-correction code sequence thus generated to the reception device 4. The transmission device 1 may transmit the modulated signal directly to the relay device 3 or may transmit the modulated signal to the relay device 3 via the relay satellite 2. The first error- correction encoding refers to encoding that uses a first error-correction code premised on soft-decision decoding.

When the relay satellite 2 receives the modulated signal from the transmission device 1, the relay satellite 2 can perform processes, such as amplification of the modulated signal and transmission medium conversion for the modulated signal, and transmit the processed signal to the relay device 3. The transmission medium conversion is, for example, a process that converts a transmission medium of the modulated signal from radio to free-space optical communication. In communication between the transmission device 1 and the relay satellite 2, the transmission device 1 may add, separately from the first error-correction code, an error-correction code that allows for relatively small circuit scale, low power consumption, and low processing load. In that case, the relay satellite 2 transmits to the relay device 3 the first error-correction code sequence after decoding.

The relay device 3 performs signal relay between the transmission device 1 and the reception device 4. At this time, the relay device 3 demodulates the modulated signal generated by the transmission device 1 and generates a soft demodulated sequence by adding reliability information to each hard-decision result of the modulated signal. Furthermore, the relay device 3 performs second error-correction encoding on the generated soft demodulated sequence as an information sequence to generate a second error-correction code sequence and modulates the generated second error-correction code sequence for transmission to the reception device 4.

For a signal received via the relay device 3, the reception device 4 decodes an error-correction code corresponding to the second error-correction encoding and then decodes the error-correction code corresponding to the first error-correction encoding.

Here, based on the assumption that a rate of transmission from the transmission device 1 of the transmitting station on the Moon to the relay device 3 on the artificial satellite orbiting the Earth is set to X Gbps in consideration of installation locations and transmission distance, a rate of transmission from the relay device 3 on the artificial satellite to the reception device 4 of the receiving station installed on the Earth can be set to 5X Gbps or higher. For example, a signal to be transmitted over a first section between the transmission device 1 and the relay device 3 is modulated using binary phase-shift keying (BPSK). If a signal to be transmitted over a second section between the relay device 3 and the reception device 4 is modulated using, for instance, 16-quadrature amplitude modulation (16-QAM), a modulation rate in the second section can be limited to 1.25 times that of the first section. If the signal to be transmitted over the second section is modulated using quadrature phase-shift keying (QPSK), the modulation rate in the second section can be limited to 2.5 times that of the first section.

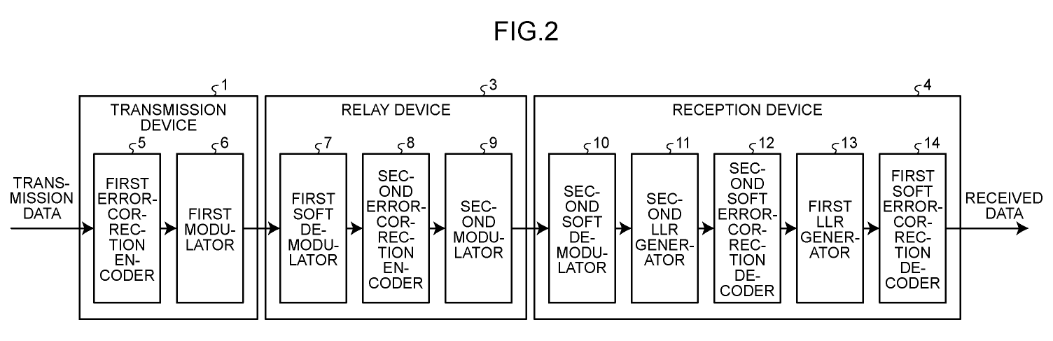

FIG. 2 is a diagram illustrating functional configurations of the transmission device 1, the relay device 3, and the reception device 4 that are illustrated in FIG. 1. The transmission device 1 includes a first error-correction encoder 5 and a first modulator 6. The relay device 3 includes a first soft demodulator 7, a second error-correction encoder 8, and a second modulator 9. The reception device 4 includes a second soft demodulator 10, a second log-likelihood ratio (LLR) generator 11, a second soft error-correction decoder 12, a first LLR generator 13, and a first soft error-correction decoder 14.

The first error-correction encoder 5 performs the first error-correction encoding process on an information sequence of transmission data to generate a first error-correction code sequence and outputs the generated first error-correction code sequence to the first modulator 6. Here, the first error-correction encoding process refers to the encoding process that uses the first error-correction code premised on the soft-decision error-correction decoding. Conceivable examples of the first error-correction code include low-density parity-check (LDPC) codes, polar codes, turbo codes, convolutional codes, block codes, and combinations of the above codes. The first error-correction encoder 5 adds a synchronization acquisition signal or the like to the first error-correction code sequence before output to the first modulator 6.

The first modulator 6 performs a first modulation process in which the first modulator 6 modulates the first error-correction code sequence, using on-off keying (OOK), BPSK, or multilevel modulation such as QPSK or QAM in consideration of factors, such as the transmission distance between the transmission device 1 and the relay device 3 and a state of transmission space, and transmits a resulting modulated signal. The transmission medium used here may be radio or optical.

Here, the signal transmitted by the transmission device 1 is assumed to be received directly by the relay device 3 without passing through the relay satellite 2.

The first soft demodulator 7 demodulates the modulated signal generated by the first modulator 6. The first soft demodulator 7 performs a demodulation process corresponding to the first modulation process, that is, a soft demodulation process in which the first soft demodulator 7 adds reliability information to each hard-decision result of the modulated signal to generate a soft demodulated sequence. Here, the soft demodulation process performed by the first soft demodulator 7, which is the demodulation process corresponding to the first modulation process, is referred to as the first soft demodulation process. The soft demodulated sequence generated by the first soft demodulation process is referred to as the first soft demodulated sequence. The first soft demodulator 7 outputs the generated soft demodulated sequence to the second error-correction encoder 8. For example, for BPSK, a soft demodulated sequence can be generated by adding multi-bit reliability information based on, for instance, a Euclidean distance between an ideal signal point and a received point to each 1-bit symbol indicating a hard-decision result. For instance, when the reliability information is represented by three bits, three reliability bits are added to one hard-decision bit, making four bits in the soft demodulated sequence.

If a soft-decision error-correction decoding process is performed on the basis of the hard-decision result and the reliability information that are included in the first soft demodulated sequence obtained by the first soft demodulator 7, error correction is possible through the soft-decision error-correction decoding even when an error rate of the hard-decision result is high. However, a circuit that performs the soft-decision error-correction decoding has a large circuit scale and consumes a large amount of power. Therefore, in the communication system 100, the relay device 3 does not perform the soft-decision error-correction decoding, but has functions of performing further error-correction encoding, modulating, and transmitting to the reception device 4, treating the soft demodulated sequence output from the first soft demodulator 7 as an information sequence.

The second error-correction encoder 8 performs the second error-correction encoding process, using the first soft demodulated sequence, which is obtained by the first soft demodulator 7 and includes the hard-decision result and the reliability information, as the information sequence. The second error-correction encoder 8 generates a second error-correction code sequence through the second error-correction encoding process and outputs the generated second error-correction code sequence to the second modulator 9.

The second modulator 9 modulates the second error-correction code sequence output from the second error-correction encoder 8 and transmits a resulting modulated signal to the reception device 4. The modulation process performed by the second modulator 9 is referred to as the second modulation process.

Here, if the signal transmitted from the transmission device 1 to the relay device 3 over the first section is modulated using BPSK, and if the first soft demodulator 7 of the relay device 3 adds the 3-bit reliability information to one hard-decision bit, an amount of information to be transmitted from the relay device 3 to the reception device 4 over the second section becomes four times larger. Accordingly, the transmission rate in the second section needs to be at least four times higher than that in the first section. However, using 16-QAM to modulate the signal to be transmitted over the second section makes it possible to limit the modulation rate in the second section to an increase approximately equal to overhead introduced by the second error-correction encoding, compared to the first section. Therefore, the second modulator 9 preferably uses a modulation scheme with a higher modulation order, or multivalue degree, than that used by the first modulator 6.

The second soft demodulator 10 of the reception device 4 generates a second soft demodulated sequence including the reliability information by performing a second soft demodulation process that is a soft demodulation process corresponding to the second modulation process performed by the second modulator 9 of the relay device 3, and outputs the generated second soft demodulated sequence to the second LLR generator 11.

The second LLR generator 11 generates reliability information, such as LLRs corresponding to the second error-correction code sequence, from the second soft demodulated sequence output by the second soft demodulator 10. The second LLR generator 11 outputs the generated LLRs to the second soft error-correction decoder 12.

The second soft error-correction decoder 12 decodes the second error-correction code sequence on the basis of the LLRs output from the second LLR generator 11 to restore the first soft demodulated sequence for the first error-correction code sequence, which has been output by the first soft demodulator 7 of the relay device 3. The second soft error-correction decoder 12 outputs the restored first soft demodulated sequence to the first LLR generator 13.

The first LLR generator 13 generates reliability information, such as LLRs corresponding to the first error-correction code sequence, from the first soft demodulated sequence output by the second soft error-correction decoder 12. The first LLR generator 13 outputs the generated LLRs to the first soft error-correction decoder 14.

The first soft error-correction decoder 14 performs a first soft error-correction decoding process that corresponds to the first error-correction encoding process to decode the first error-correction code sequence on the basis of the LLRs output from the first LLR generator 13 to generate received data and output the received data.

Here, a description is provided of hardware configurations of the transmission device 1, the relay device 3, and the reception device 4. The first error-correction encoder 5, the first modulator 6, the first soft demodulator 7, the second error-correction encoder 8, the second modulator 9, the second soft demodulator 10, the second LLR generator 11, the second soft error-correction decoder 12, the first LLR generator 13, and the first soft error-correction decoder 14 are implemented using processing circuits. Each of these processing circuits may be realized by dedicated hardware or may be a control circuit using a central processing unit (CPU).

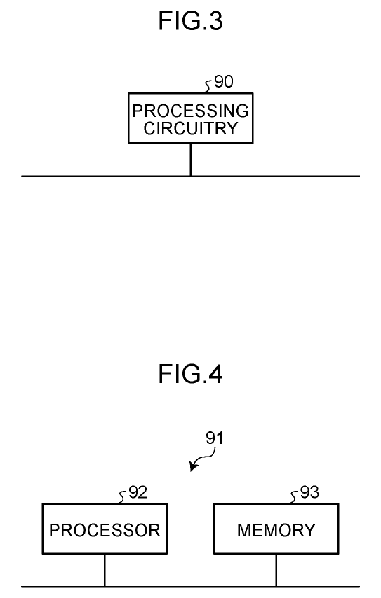

When realized by dedicated hardware, the above processing circuits are implemented by processing circuitry 90 illustrated in FIG. 3. FIG. 3 is a diagram illustrating the dedicated hardware for implementing the functions of the transmission device 1, the relay device 3, and the reception device 4 according to the first embodiment. The processing circuitry 90 is a single circuit, a composite circuit, a programmed processor, a parallel programmed processor, an application-specific integrated circuit (ASIC), a field-programmable gate array (FPGA), or any combination of these.

When the above processing circuits are realized by a control circuit using a CPU, the control circuit is, for example, a control circuit 91 having a configuration illustrated in FIG. 4. FIG. 4 is a diagram illustrating the configuration of the control circuit 91 for implementing the functions of the transmission device 1, the relay device 3, and the reception device 4 according to the first embodiment. As illustrated in FIG. 4, the control circuit 91 includes a processor 92 and a memory 93. The processor 92 is a CPU and is also referred to as an arithmetic unit, a microprocessor, a microcomputer, or a digital signal processor (DSP), among others. Examples of the memory 93 include nonvolatile and volatile semiconductor memories, such as a random-access memory (RAM), a read-only memory (ROM), a flash memory, an erasable programmable ROM (EPROM), and an electrically EPROM (EEPROM) (registered trademark), a magnetic disk, a flexible disk, an optical disk, a compact disc, a mini disc, and a digital versatile disc (DVD), among others.

When the above processing circuits are realized by the control circuit 91, the processor 92 implements the processing circuits by reading and executing programs that are stored in the memory 93 and correspond to the processes of the constituent elements. The memory 93 is also used as a temporary memory in each process that is executed by the processor 92. The programs to be executed by the processor 92 may each be provided in a form stored on a storage medium or over a communication path such as the Internet.

In the first embodiment, the reception device 4 includes the first LLR generator 13; however, the first LLR generator 13 may be implemented between the first soft demodulator 7 and the second error-correction encoder 8 of the relay device 3. When the first LLR generator 13 is implemented between the first soft demodulator 7 and the second error-correction encoder 8 of the relay device 3, the second error-correction encoder 8 performs the second error-correction encoding process, using LLR data corresponding to the first error-correction code sequence as an information sequence.

In the first embodiment, the second soft demodulator 10 in the reception device 4 performs the soft demodulation process. However, when a low probability of error occurrence is assumed between the relay device 3 and the reception device 4, the reception device 4 may perform a hard-decision demodulation process and skip the function of generating LLRs corresponding to a second error- correction code sequence, thus generating the second error-correction code sequence directly from a result of the hard-decision demodulation process. Furthermore, the reception device 4 may perform second hard-decision error-correction decoding to generate a first soft demodulated sequence or LLR data corresponding to a first error-correction code sequence.

According to the first embodiment described above, the relay device 3 can be provided to perform signal relay between the transmission device 1 that transmits a first modulated signal obtained by modulating a first error-correction code sequence generated by performing the first error-correction encoding process on an information sequence and the reception device 4 serving as a destination of the first modulated signal. This relay device 3 includes the first soft demodulator 7 that generates a first soft demodulated sequence including reliability information corresponding to the first modulated signal; the second error-correction encoder 8 that performs the second error-correction encoding process on an information sequence including the first soft demodulated sequence to generate a second error-correction code sequence; and the second modulator 9 that transmits a second modulated signal obtained by modulating the second error-correction code sequence. This allows for application of a first error-correction code premised on soft-decision decoding between the transmission device 1 and the relay device 3. Furthermore, since the relay device 3 transmits the second modulated signal obtained by performing the second error-correction encoding process on the information sequence including the soft demodulated sequence, followed by the modulation, without performing the soft-decision decoding process, the relay device 3 does not need to be equipped with a soft-decision error-correction decoding circuit, which would have a large circuit scale. Therefore, even when the transmission distance between the transmission device 1 and the relay device 3 is long enough to cause a high probability of error occurrence, enhanced communication reliability is possible without an increase in the circuit scale of the relay device 3. Additionally, the soft-decision error-correction decoding circuit would not only be large in circuit scale but also consume a large amount of power. Therefore, the relay device 3 can achieve lower power consumption than when the relay device 3 is equipped with the soft-decision error-correction decoding circuit.

The relay device 3 may be equipped with the first LLR generator 13, which is a reliability information generator that generates LLRs as a reliability information sequence corresponding to the first error-correction code sequence from the first soft demodulated sequence for the first error-correction code sequence, and the second error-correction encoder 8 may perform the second error-correction encoding process on the reliability information sequence.

The relay device 3 may be installed on a satellite. In that case, the relay device 3 can relay a first modulated signal transmitted by the transmission device 1 installed on the Moon to the reception device 4 installed on the Earth, and the satellite on which the relay device 3 is installed can be an artificial satellite orbiting the Earth.

According to the first embodiment, the communication system 100 can be provided to include the transmission device 1 that transmits a first modulated signal obtained by modulating a first error-correction code sequence generated by performing the first error-correction encoding process on an information sequence; the reception device 4 serving as a destination of the first modulated signal; and the relay device 3 that performs signal relay between the transmission device 1 and the reception device 4. In this communication system 100, the relay device 3 generates a first soft demodulated sequence including reliability information corresponding to the first modulated signal; without performing decoding, performs the second error-correction encoding process on an information sequence including the first soft demodulated sequence to generate a second error-correction code sequence; and transmits a second modulated signal obtained by modulating the second error-correction code sequence.

According to the first embodiment, the control circuit 91 can also be provided to control the relay device 3 that performs signal relay between the transmission device 1 that transmits a first modulated signal obtained by modulating a first error-correction code sequence generated by performing the first error-correction encoding process on an information sequence and the reception device 4 serving as a destination of the first modulated signal. This control circuit 91 can cause the relay device 3 to execute a step of generating a first soft demodulated sequence including reliability information corresponding to the first modulated signal; a step of performing the second error-correction encoding process on an information sequence including the first soft demodulated sequence to generate a second error-correction code sequence; and a step of transmitting a second modulated signal obtained by modulating the second error-correction code sequence.

According to the first embodiment, the storage medium can also be provided to store a program for controlling the relay device 3 that performs signal relay between the transmission device 1 that transmits a first modulated signal obtained by modulating a first error-correction code sequence generated by performing the first error-correction encoding process on an information sequence and the reception device 4 serving as a destination of the first modulated signal. The program stored on this storage medium can cause the relay device 3 to execute a step of generating a first soft demodulated sequence including reliability information corresponding to the first modulated signal; a step of performing the second error-correction encoding process on an information sequence including the first soft demodulated sequence to generate a second error-correction code sequence; and a step of transmitting a second modulated signal obtained by modulating the second error-correction code sequence.

According to the first embodiment, a communication method can also be provided. This communication method can include a step of performing, by the transmission device 1, the first error-correction encoding process on an information sequence to generate a first error-correction code sequence; a step of modulating, by the transmission device 1, the first error-correction code sequence thus generated to generate a first modulated signal; a step of transmitting, by the transmission device 1, the first modulated signal; a step of generating, by the relay device 3 that relays the first modulated signal, a first soft demodulated sequence including reliability information corresponding to the first modulated signal; a step of performing, by the relay device 3, the second error-correction encoding process on an information sequence including the first soft demodulated sequence to generate a second error-correction code sequence; a step of modulating, by the relay device 3, the second error-correction code sequence to generate a second modulated signal; a step of transmitting, by the relay device 3, the second modulated signal; and a step of receiving, by the reception device 4, the second modulated signal.

### Second Embodiment.

A communication system 100 according to a second embodiment differs from the communication system 100 according to the first embodiment only in part of the process performed by the second error-correction encoder 8 of the relay device 3, while its basic configuration is the same as that of the first embodiment. Therefore, the communication system 100 according to the second embodiment is described herein, using the same reference characters as those of the first embodiment illustrated in FIG. 2. A description is hereinafter provided mainly of the difference from the first embodiment.

Using a first soft demodulated sequence output from the first soft demodulator 7 as an information sequence, the second error-correction encoder 8 generates a second error-correction code sequence in which error-correction code parity bits are added. It is to be noted here that overhead in the second error-correction code sequence increases as error correction capability of the second error-correction encoding process improves. In addition, bits included in the first soft demodulated sequence have different degrees of influence, that is, different degrees of importance in soft-decision error-correction decoding. Accordingly, in the second embodiment, the second error-correction encoder 8 performs the second error-correction encoding with error correction capabilities corresponding to the degrees of influence of the bits of the first soft demodulated sequence in soft-decision error-correction decoding. The phrase “the degrees of influence of the bits of the first soft demodulated sequence”, or simply “the degrees of influence”, as used below, refers to “the degrees of influence of the bits of the first soft demodulated sequence in soft-decision error-correction decoding”. Specifically, the second error-correction encoder 8 can perform the second error-correction encoding with the error correction capabilities corresponding to the degrees of influence by using the error-correction code parity bits, which are parity bits whose bit lengths vary according to the degrees of influence of the bits of the first soft demodulated sequence.

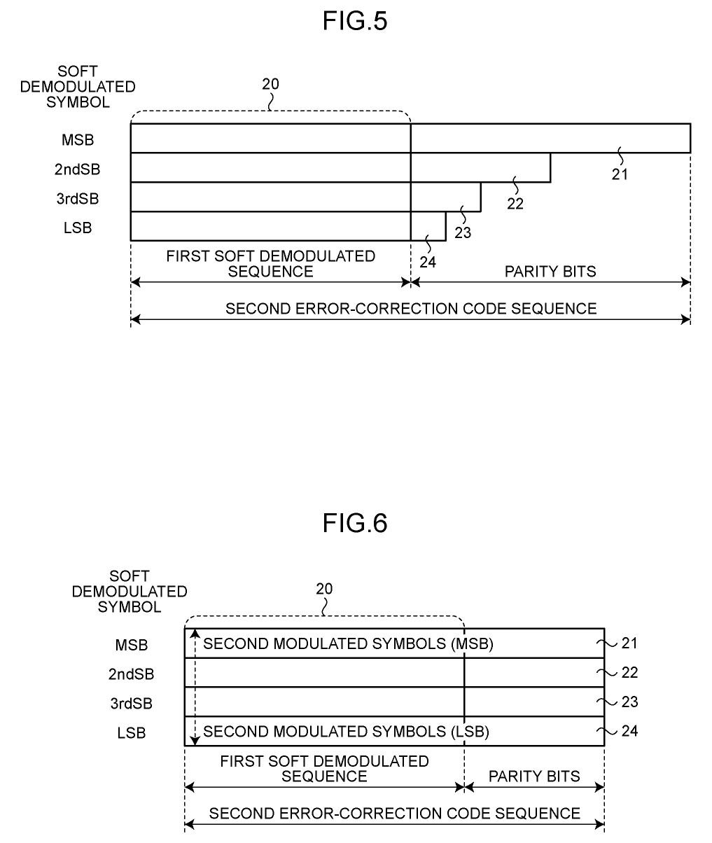

FIG. 5 is an explanatory diagram of the second error-correction encoding process according to the second embodiment. Here, a first soft demodulated sequence 20 refers to soft demodulated symbols configured to include three soft-decision bits per hard-decision bit for BPSK modulation. The four bits included in the first soft demodulated sequence 20 are referred to as the most significant bit (MSB), the 2ndSB, the 3rdSB, and the least significant bit (LSB) in order of decreasing significance. For example, the MSB in the first soft demodulated sequence 20 is the hard-decision bit, which indicates a hard-decision result of a modulated signal generated by the first modulation process, while the 2ndSB, the 3rdSB, and the LSB are reliability bits indicating reliability of the hard-decision bit. It is to be noted here that among the four bits of the first soft demodulated sequence 20, the MSB has the highest degree of influence, followed by the 2ndSB, the 3rdSB, and the LSB in order of decreasing influence.

In the example illustrated in FIG. 5, the second error-correction encoder 8 performs the second error-correction encoding with different error correction capabilities respectively for the MSB, the 2ndSB, the 3rdSB, and the LSB. In other words, the second error-correction encoder 8 adds parity bits 21 with the highest error correction capability to the MSB, which has the highest degree of influence in soft-decision error-correction decoding. According to the respective degrees of influence of the 2ndSB, the 3rdSB, and the LSB, the second error-correction encoder 8 adds generated parity bits 22 to the 2ndSB, generated parity bits 23 to the 3rdSB, and generated parity bits 24 to the LSB. As illustrated in FIG. 5, the parity bits 21, the parity bits 22, the parity bits 23, and the parity bits 24 have bit lengths decreasing in this order. Thus, the second error-correction encoder 8 performs the second error-correction encoding with higher error correction capabilities on the hard-decision bit, which is the MSB, than on the reliability bits, which are the 2ndSB, the 3rdSB, and the LSB.

In the second embodiment, the second error-correction encoder 8 performs the second error-correction encoding with the different error correction capabilities respectively for the MSB, the 2ndSB, the 3rdSB, and the LSB, adding the parity bits 21 to 24 that vary in length to the MSB, the 2ndSB, the 3rdSB, and the LSB. In this way, the second error-correction encoder 8 generates a second error-correction code sequence for each bit included in the soft demodulated sequence. However, the second error-correction encoder 8 may use any method as long as the second error-correction encoder 8 can perform the second error-correction encoding with error correction capabilities corresponding to the respective degrees of influence of the MSB, the 2ndSB, the 3rdSB, and the LSB in soft-decision error-correction decoding. For example, the second error-correction encoder 8 may perform the error-correction encoding on the MSB and 2ndSB collectively and perform the error-correction encoding on the 3rdSB and the LSB collectively. Alternatively, the second error-correction encoder 8 may add parity bits to the MSB to generate one second error-correction code sequence and add parity bits collectively to the 2ndSB, the 3rdSB, and the LSB to generate another second error-correction code sequence. In that case, the parity bits added to the MSB and the parity bits added collectively to the 2ndSB, the 3rdSB, and the LSB are to have the same bit length, thereby providing the MSB with a higher error correction capability than that for each of the 2ndSB, the 3rdSB, and the LSB.

According to the second embodiment described above, the second error-correction encoder 8 of the relay device 3 can perform the second error-correction encoding process with the error correction capabilities corresponding to the degrees of influence, in soft-decision error-correction decoding, of the bits of the first soft demodulated sequence 20. Consequently, the relay device 3 can reduce the overhead in the second error-correction code sequence compared to a case where, for example, the error correction capability required for the MSB is applied to all the bits in the first soft demodulated sequence 20 such that every bit is provided with the high error correction capability.

According to the second embodiment, the first soft demodulator 7 generates the first soft demodulated sequence 20 that includes the hard-decision bit (e.g., the MSB) indicating the hard-decision result of the first modulated signal and the reliability bits (e.g., the 2ndSB, the 3rdSB, and the LSB) indicating the reliability of the hard-decision bit. The second error-correction encoder 8 can perform the second error-correction encoding process with the higher error correction capability on the hard-decision bit than on the reliability bits.

In the case where the second error-correction encoder 8 performs the second error-correction encoding process collectively on the multiple bits after the first soft demodulator 7 generates the first soft demodulated sequence 20, which includes the hard-decision bit indicating the hard-decision result of the first modulated signal and the reliability bits indicating the reliability of the hard-decision bit, the second error-correction encoder 8 can perform the second error-correction encoding process with a higher error correction capability on an information sequence including the hard-decision bit than on an information sequence not including the hard-decision bit.

### Third Embodiment.

A communication system 100 according to a third embodiment differs from the communication system 100 according to the first embodiment only in part of the process performed by the second modulator 9 of the relay device 3, while its basic configuration is the same as that of the first embodiment. Therefore, the communication system 100 according to the third embodiment is described herein, using the same reference characters as those of the first embodiment illustrated in FIG. 2. A description is hereinafter provided mainly of the difference from the first embodiment.

In the third embodiment, the second modulator 9 performs the multilevel modulation process to generate second modulated symbols, that is, multilevel modulation symbols from a second error-correction code sequence. For example, a modulation scheme used by the second modulator 9 is multilevel modulation such as QAM. On the basis of degrees of influence, in soft-decision decoding, of bits of a first error-correction code sequence included in the second error-correction code sequence and probabilities of error occurrence of bits included in the second modulated symbols, the second modulator 9 assigns bits included in the second error-correction code sequence to the bits of the multilevel modulation symbols.

FIG. 6 is an explanatory diagram of the second modulation process according to the third embodiment. The first soft demodulated sequence 20, which is the soft demodulated sequence corresponding to the first error-correction code sequence and is output from the first soft demodulator 7, refers to the 4-bit soft demodulated symbols, each composed of the MSB, the 2ndSB, the 3rdSB, and the LSB. The second error-correction encoder 8 adds the parity bits 21 to 24 to the first soft demodulated sequence 20 to generate second error-correction code sequences. Here, while the second error-correction code sequences are configured as in the second embodiment, the parity bits 21 to 24 have the same bit length, meaning that the same error correction capability is provided for each of the bits. The second error-correction encoder 8 outputs the second error-correction code sequences, which are configured as illustrated in FIG. 6, to the second modulator 9. The second modulator 9 assigns the bits of the second error-correction code sequences to the bits of the second modulated symbols such that the degrees of influence, in soft-decision error-correction decoding, of the bits of the first error-correction code sequence included in the second error-correction code sequences correspond to the probabilities of error occurrence of bits of the second modulated symbols. Specifically, the second modulator 9 performs mapping such that bits with higher degrees of influence in the second error-correction code sequences are assigned to bits with lower probabilities of error occurrence in the second modulated symbols. More specifically, the second modulator 9 regards the parity bits 21 to 24 as having degrees of influence that are respectively identical to the degrees of influence of the bits in the first soft demodulated sequence 20 that correspond to the parity bits 21 to 24.

Here, the modulation scheme used by the second modulator 9 is assumed to be 16-QAM. In this case, the second modulator 9 assigns the MSB of the first soft demodulated sequence 20, the parity bits 21 generated for the MSB, the 2ndSB, and the parity bits 22 generated for the 2ndSB to MSBs of the second modulated symbols. The second modulator 9 assigns the 3rdSB of the first soft demodulated sequence 20, the parity bits 23 generated for the 3rdSB, the LSB, and the parity bits 24 generated for the LSB to LSBs of the second modulated symbols. This enables the generation of the second error-correction code sequences consistent with the degrees of influence of the first error-correction code sequence in soft-decision decoding.

As in the second embodiment, the MSB and the 2ndSB may collectively undergo the second error-correction encoding process, and the 3rdSB and the LSB may collectively undergo the second error-correction encoding process.

As described above, the second modulator 9 according to the third embodiment performs the multilevel modulation process to generate the multilevel modulation symbols from the second error-correction code sequences and can assign the bits of the second error-correction code sequences to the bits of the multilevel modulation symbols on the basis of the degrees of influence, in soft-decision decoding, of the bits of the first error-correction code sequence included in the second error-correction code sequences and the probabilities of error occurrence of the bits in the multilevel modulation symbols. This allows for simplified configuration of the second error-correction encoder 8 and improved error correction capability in soft-decision error-correction decoding of the first error-correction code sequence.

The above configurations illustrated in the embodiments are illustrative, can be combined with other techniques that are publicly known, and can be partly omitted or changed without departing from the gist. The embodiments can be combined with each other.

Furthermore, in the above-described embodiments, the transmission device 1 is installed on the Moon, which is a satellite of the Earth, the reception device 4 is installed on the Earth, and the relay device 3 is installed on the artificial satellite orbiting the Earth. However, the above exemplary installation locations of these devices are not limiting. The transmission device 1, the relay device 3, and the reception device 4 may all be installed on the Earth or on a planet other than the Earth. Alternatively, the reception device 4 may be installed on a planet other than the Earth, the transmission device 1 may be installed on a satellite of the planet on which the reception device 4 is installed, and the relay device 3 may be installed on an artificial satellite orbiting the planet on which the reception device 4 is installed. While the installation locations of the transmission device 1, the relay device 3, and the reception device 4 are not limited, the configuration of the relay device 3 is suitable particularly when the transmission distance between the transmission device 1 and the relay device 3 is long.

The relay device according to the present disclosure has an effect of preventing a reduction in communication reliability even when the transmission distance from the transmission device to the relay device is long.

What is claimed is:

1. A relay device to perform signal relay between a transmission device and a reception device, the transmission device being configured to transmit a first modulated signal obtained by modulating a first error-correction code sequence generated by performing a first error-correction encoding process on an information sequence, the reception device serving as a destination of the first modulated signal, the relay device comprising:
a first soft demodulator to generate a first soft demodulated sequence including reliability information corresponding to the first modulated signal;
a second error-correction encoder to perform a second error-correction encoding process on an information sequence including the first soft demodulated sequence to generate a second error-correction code sequence; and
a second modulator to transmit a second modulated signal obtained by modulating the second error-correction code sequence.

2. The relay device according to claim 1, further comprising
a reliability information generator to generate a reliability information sequence corresponding to the first error-correction code sequence from the first soft demodulated sequence for the first error-correction code sequence, wherein
the second error-correction encoder performs the second error-correction encoding process on the reliability information sequence.

3. The relay device according to claim 1, wherein
the second error-correction encoder performs the second error-correction encoding process with error correction capabilities corresponding to degrees of influence of bits of the first soft demodulated sequence in soft-decision error-correction decoding.

4. The relay device according to claim 2, wherein
the second error-correction encoder performs the second error-correction encoding process with error correction capabilities corresponding to degrees of influence of bits of the first soft demodulated sequence in soft-decision error-correction decoding.

5. The relay device according to claim 3, wherein
the first soft demodulator generates the first soft demodulated sequence that includes a hard-decision bit indicating a hard-decision result of the first modulated signal and reliability bits indicating reliability of the hard-decision bit, and
the second error-correction encoder performs the second error-correction encoding process with a higher error correction capability on the hard-decision bit than on the reliability bits.

6. The relay device according to claim 4, wherein
the first soft demodulator generates the first soft demodulated sequence that includes a hard-decision bit indicating a hard-decision result of the first modulated signal and reliability bits indicating reliability of the hard-decision bit, and
the second error-correction encoder performs the second error-correction encoding process with a higher error correction capability on the hard-decision bit than on the reliability bits.

7. The relay device according to claim 3, wherein
the first soft demodulator generates the first soft demodulated sequence that includes a hard-decision bit indicating a hard-decision result of the first modulated signal and reliability bits indicating reliability of the hard-decision bit, and
the second error-correction encoder performs the second error-correction encoding process with a higher error correction capability on an information sequence including the hard-decision bit than on an information sequence not including the hard-decision bit.

8. The relay device according to claim 4, wherein
the first soft demodulator generates the first soft demodulated sequence that includes a hard-decision bit indicating a hard-decision result of the first modulated signal and reliability bits indicating reliability of the hard-decision bit, and
the second error-correction encoder performs the second error-correction encoding process with a higher error correction capability on an information sequence including the hard-decision bit than on an information sequence not including the hard-decision bit.

9. The relay device according to claim 1, wherein
the second modulator performs a multilevel modulation process to generate multilevel modulation symbols from the second error-correction code sequence, assigning bits included in the second error-correction code sequence to bits included in the multilevel modulation symbols on a basis of degrees of influence, in soft-decision decoding, of bits of the first error-correction code sequence included in the second error-correction code sequence and probabilities of error occurrence of the bits of the multilevel modulation symbols.

10. The relay device according to claim 2, wherein
the second modulator performs a multilevel modulation process to generate multilevel modulation symbols from the second error-correction code sequence, assigning bits included in the second error-correction code sequence to bits included in the multilevel modulation symbols on a basis of degrees of influence, in soft-decision decoding, of bits of the first error-correction code sequence included in the second error-correction code sequence and probabilities of error occurrence of the bits of the multilevel modulation symbols.

11. The relay device according to claim 1, wherein
the relay device is installed on a satellite.

12. The relay device according to claim 2, wherein
the relay device is installed on a satellite.

13. The relay device according to claim 11, wherein
the relay device relays the first modulated signal transmitted by the transmission device installed on the Moon to the reception device installed on the Earth.

14. The relay device according to claim 12, wherein
the relay device relays the first modulated signal transmitted by the transmission device installed on the Moon to the reception device installed on the Earth.

15. A communication system comprising:
a transmission device to transmit a first modulated signal obtained by modulating a first error-correction code sequence generated by performing a first error-correction encoding process on an information sequence;
a reception device serving as a destination of the first modulated signal; and
a relay device to perform signal relay between the transmission device and the reception device, wherein
the relay device generates a first soft demodulated sequence including reliability information corresponding to the first modulated signal; without performing decoding, performs a second error-correction encoding process on an information sequence including the first soft demodulated sequence to generate a second error-correction code sequence; and transmits a second modulated signal obtained by modulating the second error-correction code sequence.

16. A communication method comprising:
performing a first error-correction encoding process on an information sequence to generate a first error-correction code sequence;
modulating the first error-correction code sequence thus generated to generate a first modulated signal;
transmitting the first modulated signal;
generating a first soft demodulated sequence including reliability information corresponding to the first modulated signal;
performing a second error-correction encoding process on an information sequence including the first soft demodulated sequence to generate a second error-correction code sequence;
modulating the second error-correction code sequence to generate a second modulated signal;
transmitting the second modulated signal; and
receiving the second modulated signal.
